(19) United States
(12) Patent Application Publication
(10) Pub. No.: US 2026/0080524 A1
(43) Pub. Date: Mar. 19, 2026

(54) SYSTEM AND METHOD FOR PROCESSING RECYCLED METAL USING AI AND COMPUTER PROGRAM FOR THE SAME

(71) Applicant: REMETAL INTERNATIONAL INC, Incheon (KR)

(72) Inventor: Hwan Cheol YEO, FULLERTON, CA (US)

(21) Appl. No.: 18/929,611

(22) Filed: Oct. 29, 2024

(30) Foreign Application Priority Data
Sep. 19, 2024 (KR) 10-2024-0126442

(51) Int. Cl. G06T 7/00; G06Q 30/018; G06T 5/10; G06T 5/70; G06V 10/30; G06V 10/764

(52) U.S. Cl. CPC G06T 7/0004; G06Q 30/018; G06T 5/10; G06T 5/70; G06V 10/30; G06V 10/764; G06T 2207/20048; G06T 2207/20084; G06T 2207/30136

(57) ABSTRACT

A recycled metal processing system and method using artificial intelligence (AI) and a computer program for the same are discloses. The recycled metal processing system using AI may include: a vision camera installed above metal scrap that is crushed, the vision camera being configured to obtain a captured image by capturing an image of an upper part of the metal scrap; and a grade determining unit configured to determine a grade of the metal scrap according to a preset quality criterion, by analyzing the captured image based on an AI model.

### CROSS-REFERENCE TO RELATED APPLICATION

This application claims priority to Korean Patent Application No. 10-2024-0126442, filed on Sep. 19, 2024, and all the benefits accruing therefrom under 35 U.S.C. § 119, the contents of which in its entirety are herein incorporated by reference.

### BACKGROUND

### 1. Field

The present disclosure relates to a recycled metal processing system and method using artificial intelligence (AI) and a computer program for the same, and more particularly, to a recycled metal processing system and method using AI and a computer program for the same, which may classify a grade of crushed metal scrap according to a preset quality criterion, may determine a grade, and may calculate and provide carbon emissions according to a processing process and a grade determination result.

### 2. Description of the Related Art

Metal scrap is generated from a steel production process, a processing process of the steel-demand industry, or waste from steel-based products, is collected through a collection process of metal scrap distributors, and then is transported to a processing facility or a steel mill by using a vehicle.

In this case, a grade of the metal scrap transported to the processing facility or the steel mill is classified by an inspector by directly checking a type or a condition of the metal scrap with eyes or by checking the metal scrap on a monitor, and the cost according to the classified grade and a weight of the metal scrap is paid to a supplier.

Currently, a grade, purity, etc. of metal scrap in most sits are determined by visual inspection by an inspector of a specific institution or a quality inspection team of each manufacturer. All transactions are accompanied by a quality compensation procedure after delivery due to quality deviation in transactions between countries as well as Korea, with an average of 1.0% post-compensation.

Although numerous metal scraps such as iron, copper, aluminum, and stainless steel have recently been traded, the development of artificial intelligence (AI) inspection is attempted only for metal scrap with the largest volume of transactions and severe quality deviation, and AI inspection is used by steel companies for quality control of warehoused products, and thus, is not suitable for relatively small distribution companies.

Also, AI inspection models are trained according to domestic standards of each country and self-standards of large buyers, making it difficult to have universality in international transection markets.

### SUMMARY

The present disclosure is directed to providing a recycled metal processing system and method using artificial intelligence (AI) and a computer program for the same, which may classify a grade of crushed metal scrap according to a preset quality criterion, may determine a grade, and may calculate and provide carbon emissions according to a processing process and a grade determination result.

According to an embodiment, a recycled metal processing system using artificial intelligence (AI) comprises: a vision camera installed above metal scrap that is crushed, the vision camera being configured to obtain a captured image by capturing an image of an upper part of the metal scrap; and a grade determining unit configured to determine a grade of the metal scrap according to a preset quality criterion, by analyzing the captured image based on an AI model.

According to an embodiment, according to the quality criterion, a grade is classified into a plurality of grades according to whether the metal scrap corresponds to a vehicle outer skin, whether the metal scrap has a thickness of 3 mm or less, and whether the metal scrap has a thickness of 3 mm or less and is surface-plated, and the grade determining unit is configured to classify a grade of the metal scrap based on the quality criterion.

According to an embodiment, the grade determining unit comprises: a filtering unit configured to filter out shadow noise formed by lighting, a thermal noise component, and a dust noise component formed by scattering dust in the obtained captured image; and a Fourier transform unit configured to perform Fourier transform on the filtered captured image.

According to an embodiment, the recycled metal processing system using AI further comprises a carbon emission calculating unit configured to calculate carbon emissions generated in a processing process of the metal scrap and a grade determination result for the metal scrap, generate a grade report on recycled metal based on the carbon emissions, and provide the grade report to a management terminal.

According to an embodiment, a recycled metal processing method using artificial intelligence (AI) comprises: obtaining, through a vision camera installed above metal scrap that is crushed, a captured image by capturing an image of an upper part of the metal scrap; determining, through a grade determining unit, a grade of the metal scrap according to a preset quality criterion, by analyzing the captured image based on an AI model; and through a carbon emission calculating unit, calculating carbon emissions generated in a processing process of the metal scrap and a grade determination result for the metal scrap, generating a grade report on recycled metal based on the carbon emissions, and providing the grade report to a management terminal.

According to an embodiment, a computer program stored in a computer-readable recording medium comprising a sequence of instructions for providing a recycled metal processing system using artificial intelligence (AI). Herein, when the computer program is executed by a computing device, the sequence of instructions cause the computing device to: obtain, through a vision camera installed above metal scrap that is crushed, a captured image by capturing an image of an upper part of the metal scrap, determine a grade of the metal scrap according to a preset quality criterion, by analyzing the captured image based on an AI model, calculate carbon emissions generated in a processing process of the metal scrap and a grade determination result for the metal scrap, generate a grade report on recycled metal based on the carbon emissions, and provide the grade report to a management terminal.

According to the present disclosure, a grade of crushed metal scrap may be classified according to a preset quality criterion and then determined, and carbon emissions may be calculated and provided according to a processing process and a grade determination result.

In particular, according to the present disclosure, a distribution company in addition to a steel company may rapidly and accurately automate the quality inspection of metal scrap.

### BRIEF DESCRIPTION OF THE DRAWINGS

FIG. 1 is a diagram schematically illustrating an overall configuration of a recycled metal processing system 100 using artificial intelligence (AI) according to an embodiment of the present disclosure.

FIG. 2 is a conceptual diagram illustrating an overall concept of determining a grade of metal scrap by using the recycled metal processing system 100 using AI.

FIG. 3 is a diagram illustrating a schematic embodiment in which a grade determining unit 120 classifies a grade of metal scrap based on a captured image.

FIG. 4 is a diagram schematically illustrating a hardware configuration of the recycled metal processing system 100 using AI according to an embodiment of the present disclosure.

FIG. 5 is a flowchart sequentially illustrating a recycled metal processing method using AI according to an embodiment of the present disclosure.

### DETAILED DESCRIPTION

Embodiments of the present disclosure will be described in detail with reference to accompanying drawings. However, in the description of the present disclosure, certain detailed explanations of well-known functions or configurations are omitted when it is deemed that they may unnecessarily obscure the essence of the present disclosure.

In the accompanying drawings, the same or corresponding components are denoted by the same reference numerals. Also, in the description of the following embodiments, repeated descriptions of the same or corresponding components will be omitted. However, even when a description of such components is omitted, such components are not intended to be excluded in an embodiment.

The advantages and features of embodiments of the present disclosure and methods of achieving the advantages and features will be described more fully with reference to the accompanying drawings, in which embodiments of the present disclosure are shown. The present disclosure may, however, be embodied in many different forms and should not be construed as being limited to the embodiments set forth herein; rather these embodiments are provided so that this disclosure will be thorough and complete, and will fully convey the concept of the present disclosure to one of ordinary skill in the art.

The terms used herein will be briefly described, and disclosed embodiments of the present disclosure will be described in detail. The terms used herein are general terms currently widely used in the art in consideration of functions in the present disclosure, but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the present disclosure.

As used herein, the singular forms “a,” “an,” and “the” are intended to include the plural forms as well, unless the context clearly indicates otherwise. Also, the plural forms are intended to include the singular forms as well, unless the context clearly indicates otherwise. It will be understood that when a certain part “includes” a certain component, the part does not exclude another component but may further include another component, unless the context clearly dictates otherwise.

Also, the term “module” or “unit” used herein refers to a software component or a hardware component, and the “module” or “unit” performs certain tasks. However, the term “module” or “unit” does not mean to be limited to software or hardware. A “module” or a “unit” may be configured to be in an addressable storage medium or may be configured to operate one or more processors. Accordingly, a “module” or a “unit” may include, by way of example, at least one of components such as software components, object-oriented software components, class components, and task components, processes, functions, attributes, procedures, subroutines, segments of program code, drivers, firmware, microcode, circuitry, data, databases, data structures, tables, arrays, or variables. Functions provided in the components and the “modules” or “parts” may be combined into a smaller number of components and “modules” or “parts”, or further divided into additional components and “modules” or “parts.”

According to an embodiment of the present disclosure, a “module” or “part” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other configuration. Also, the term “memory” should be interpreted broadly to encompass any electronic component capable of storing electronic information. The term “memory” may refer to various types of processor-readable media such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or optical data storage, registers, etc. A memory may be said to be in electronic communication with a processor when the processor may read information from and/or write information to the memory. Also, a memory integrated in a processor may be in electronic communication with the processor.

In the present disclosure, a “system” may include at least one of, but not limited to, a computing device including a device management device, a server device, and a cloud device. For example, a system may include one or more computing devices or server devices. In another example, a system may include one or more cloud devices. In another example, a system may be configured and operate together with a computing device or a server device and a cloud device.

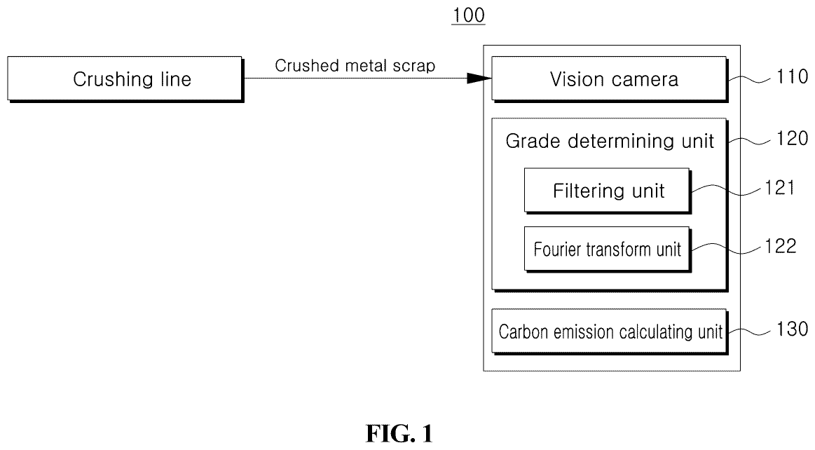

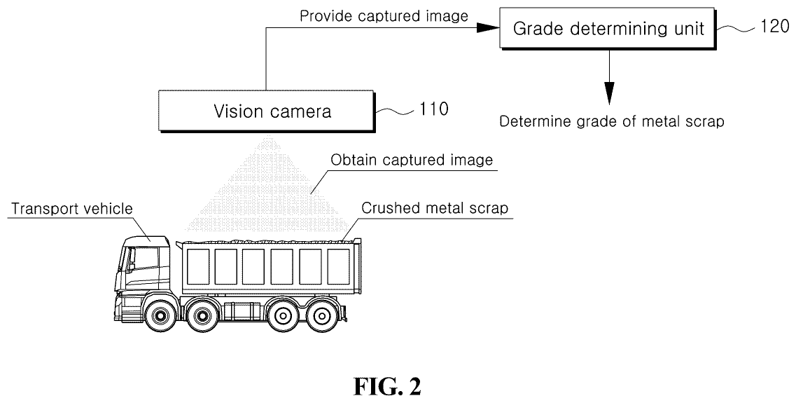

FIG. 1 is a diagram schematically illustrating an overall configuration of a recycled metal processing system 100 using artificial intelligence (AI) according to an embodiment of the present disclosure. FIG. 2 is a conceptual diagram illustrating an overall concept of determining a grade of metal scrap by using the recycled metal processing system 100 using AI.

Referring to FIGS. 1 and 2, the recycled metal processing system 100 using AI may roughly include a vision camera 110, a grade determining unit 120, and a carbon emission calculating unit 130.

First, the vision camera 110 may capture an image of metal scrap classified into ferrous scrap, non-ferrous scrap, and other metals and then crushed to obtain a captured image and may provide the captured image to the grade determining unit 120.

To this end, the vision camera 110 may be installed at a high position in a factory to photograph an upper part of the metal scrap. In this case, the metal scrap may be crushed and then loaded into a cargo space of a transport vehicle (e.g., a truck) to be sold to a metal melting plant. In an embodiment, the vision camera 110 may capture an image of metal scrap piled up in a specific location to obtain a captured image when necessary in addition to the metal scrap loaded into the transport vehicle.

The captured image obtained through the vision camera 110 may be used to identify a type of the metal scrap and analyze a size, a shape, a color, and a surface condition of the metal scrap.

In an embodiment, the vision camera 110 may obtain a high-resolution captured image and may convert the captured image into digital data that may be processed by software.

Also, in an embodiment, in order to reflect reflection characteristics of a surface of the metal scrap, the vision camera 110 may minimize reflection by using lighting of a specific wavelength and grasp surface details.

The grade determining unit 120 may analyze the captured image obtained through the vision camera 110 based on an AI model and may determine a grade of the metal scrap according to a preset quality criterion.

In more detail, the grade determining unit 120 may identify a type of the metal scrap by analyzing a material, a color, and a surface condition of the metal scrap based on the captured image obtained through the vision camera 110 and may classify by size or determine a processing process by measuring a length, a width, and a thickness of the metal scrap, and may also inspect a grade by detecting defects or impurities on the surface of the metal scrap.

According to the quality criterion, a grade may be classified into a plurality of grades (e.g., A, B, D, etc.) according to whether the metal scrap corresponds to a vehicle outer skin, whether the metal scrap has a thickness of 3 mm or less, and whether the metal scrap has a thickness of 3 mm or less and is surface-plated.

In this case, the grade determining unit 120 may first perform a preprocessing process on the obtained captured image.

To this end, the grade determining unit 120 may include a filtering unit 121 configured to filter out shadow noise formed by lighting, a thermal noise component, and a dust noise component formed by scattering dust in the obtained captured image and a Fourier transform unit 122 configured to perform Fourier transform on the filtered captured image.

The captured image obtained through the vision camera 110 may include multidirectional shadow noise caused by a plurality of lighting devices installed at an image-capturing site and may also include fine thermal noise generated from the vision camera 110 and dust noise caused by numerous scattering dust.

Accordingly, in an embodiment, the filtering unit 121 may include a bilateral filter capable of removing thermal noise while preserving a linear component of the metal scrap. The bilateral filter may remove noise while preserving an outline of the metal scrap in the captured image.

Also, in an embodiment, the filtering unit 121 may include a haze removal filter capable of filtering out a dust noise component in a blurred captured image to remove scattering dust in the image-capturing site. The haze removal filter may be used to obtain a clear image by removing noise caused by haze or fog from the captured image. The haze removal filter mainly operates by modeling and correcting noise caused by atmospheric scattering in an image.

Accordingly, the filtering unit 121 of the present disclosure may effectively remove fine noise in the captured image by using the haze removal filter capable of removing noise while preserving an outline well.

In particular, in this process, the filtering unit 121 may calculate a pixel value of the captured image (a pixel value of the captured image that is clear without haze) through Equation 1.

$$J ( x ) > \frac{I ( x ) - A}{max ( t ( x ) , {t}_{0} )} + A \qquad [ Equation 1 ]$$

Here, J(x) denotes a pixel value of the captured image from which a dust noise component caused by scattering dust is removed through haze removal filtering, I(x) denotes a pixel value of the input captured image, t(x) denotes a transmission map in which haze affects a pixel in the captured image, and A denotes atmospheric light of a brightest portion in the captured image.

In this case, the filtering unit 121 may set a minimum value of t0 to 0.1 in order to prevent t0 from having a too small value.

By using Equation 1, the filtering unit 121 may obtain a clear captured image with reduced noise by removing haze in the captured image.

Also, in this process, the filtering unit 121 may use Equation 2 in order to calculate the transmission rate t(x).

$$t ( x ) = 1 - ω \cdot {min}_{y ∈ Ω ( x )} ( \frac{I ( y )}{A} ) \qquad [ Equation 2 ]$$

Here, w denotes a transmission rate adjustment parameter value (0.95), and Ω(x) denotes a set of peripheral pixels for a pixel x.

By using Equation 2, the filtering unit 121 may calculate the transmission rate t(x) based on a darkest portion (minimum value) in the captured image.

Also, in an embodiment, the Fourier transform unit 122 may preserve geometric information of the metal scrap in the captured image and reduce lighting influence by using a homo-morphic filter.

The homo-morphic filter is a filter for relatively removing shadow influence by separating a lighting component that is a low-frequency component and a reflection component that is a high-frequency component in an image by using a logarithm, filtering a low-frequency band through Fourier transform, and performing inverse Fourier transform.

Also, in this process, the Fourier transform unit 122 may perform Fourier transform on the captured image by using Equation 3.

$$\{ I ( x , y ) \} = \hat{I} ( u , υ ) = {\sum }_{x = 0}^{M - 1} {\sum }_{y = 0}^{N - 1} I ( x , y ) {e}^{- j 2 π ( \frac{ux}{M} + \frac{uy}{N} )} \qquad [ Equation 3 ]$$

Here, I(x,y) denotes the input captured image, Î(u, v): denotes the captured image in a frequency domain, (u, v) denotes frequency coordinates, M and N denote a horizontal size and a vertical size of the captured image, and denotes an imaginary unit.

By using Equation 3, the Fourier transform unit 122 performs two-dimensional Fourier transform on the captured image to convert the captured image into a frequency domain.

When the conversion of the captured image into the frequency domain is completed, the Fourier transform unit 122 removes a shadow by removing or adjusting a low-frequency component in the captured image by using a high-pass filter (HPF).

Also, the Fourier transform unit 122 may finally obtain a clear captured image from which shadow noise is removed, by converting the captured image of the frequency domain passing through the high-pass filter back into a spatial domain by using Equation 4.

$${I}_{shadow - free} ( x , y ) = {- 1}^{} \{ \{ I ( x , y ) \} \cdot ( 1 - {e}^{- \frac{( {u}^{2} + {υ}^{2} )}{2 {σ}^{2}}} ) \} \qquad [ Equation 4 ]$$

Here, I_{shadow-free}(x, y) denotes a final captured image obtained by removing a shadow from the original captured image.

Also, in an embodiment, the grade determining unit 120 may analyze the preprocessed capture image based on an AI model. The AI model may be a neural network algorithm model to which any of various deep learning techniques is applied such as a convolutional neural network (CNN) based on an inception module having excellent performance in image recognition, a deep neural network (DNN), a recurrent neural network (RNN), a restricted Boltzmann machine, a deep belief network (DBN), or a deep Q-network.

The grade determining unit 120 may determine the quality (or grade) of the metal scrap (the metal scrap may be located into the transport vehicle) according to whether the metal scrap corresponds to a vehicle outer skin, whether the metal scrap has a thickness of 3 mm or less, and whether the metal scrap has a thickness of 3 mm or less and is surface-plated through the preprocessed captured image, which will be described in more detail as follows.

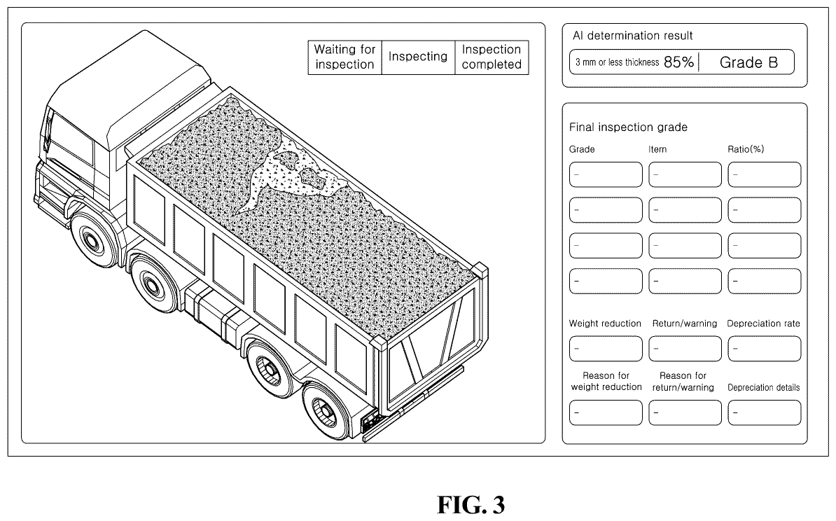

FIG. 3 is a diagram illustrating a schematic embodiment in which the grade determining unit 120 classifies a grade of metal scrap based on a captured image.

Referring to FIG. 3, the grade determining unit 120 may determine whether the metal scrap corresponds to a vehicle outer skin, the metal scrap has a thickness of 3 mm or less, or whether the metal scrap has a thickness of 3 mm or less and is surface-plated by using a classification DNN model for the obtained captured image, and may classify a grade of the metal scrap into A, B, D, etc. based on a determination result.

In particular, in this process, the grade determining unit 120 may visualize by overlapping the captured image and a grade classification prediction result of the metal scrap together. For example, the grade determining unit 120 may visualize an area close to a specific grade of the metal scrap (A, B, D, etc.) from among areas of the metal scrap in red or blue so that a worker or a manager recognizes the area more easily.

The carbon emission calculating unit 130 may calculate carbon emissions generated in a processing process of the metal scrap and a grade determination result for the metal scrap through the grade determining unit 120, may generate a grade report on recycled metal based on the calculated carbon emissions, and may provide the grade report to a management terminal.

In more detail, the carbon emission calculating unit 130 may calculate carbon emissions based on a material consumed in a metal scrap processing plant and corresponding energy consumption.

For example, the carbon emission calculating unit 130 may convert either or both of purchase history and emission factor information into standardized information so that a purchase history and an emission factor for each metal scrap purchased from the metal scrap processing plant are correlated, and may calculate carbon emissions corresponding to the purchase history based on the standardized information. The standardized information does not refer to information with a fixed time point or unit, but may refer to any form in which one or more of both information are converted so that a user's purchase history and emission factor are correlated.

Also, in an embodiment, the carbon emission calculating unit 130 may determine carbon emissions generated in a process of processing a specific amount of specific classified metal scrap by using an AI model.

In more detail, the carbon emission calculating unit 130 may first define a basic variable to determine carbon emissions generated in a process of processing a specific amount of specific classified metal scrap, by using a neural network algorithm model to which any of various deep learning techniques is applied such as a convolutional neural network (CNN), a deep neural network (DNN), a recurrent neural network (RNN), a restricted Boltzmann machine, a deep belief network (DBN), or a deep Q-network.

For example, Q may denote a total amount of processed metal scrap (tons), E may denote energy required to process 1 ton of metal scrap (kWh/ton), η may denote energy efficiency of a process (0<η<1), CE may denote a carbon emission factor according to energy consumption (kg CO₂e/kWh), and CP may denote carbon emissions directly generated in a metal scrap processing process (kg CO₂e/ton).

In this case, the carbon emission calculating unit 130 may calculate carbon emissions due to energy consumption based on Equation 5.

$${C}_{energy} = Q \times \frac{E}{η} \times {C}_{E} \qquad [ Equation 5 ]$$

Here,

$$\frac{E}{η}$$

denotes an energy value actually consumed by considering process efficiency, and C_{energy} denotes carbon emissions generated due to energy consumption.

Also, the carbon emission calculating unit 130 may calculate total carbon emissions based on Equation 6.

$${C}_{total} = Q \times ( \frac{E}{η} \times {C}_{E} + {C}_{P} ) \qquad [ Equation 6 ]$$

Here, Cₜₒₜₐₗ denotes carbon emissions generated in a process of processing Q tons of metal scrap.

Accordingly, the carbon emission calculating unit 130 may determine carbon emissions generated in an overall processing process based on the amount of processed metal scrap, energy efficiency of the process, an energy carbon emission factor, and carbon emissions directly generated from the process.

Based on this, the carbon emission calculating unit 130 may calculate carbon emissions generated when processing a specific amount of metal scrap, thereby making it possible to evaluate and optimize the environmental impact of the process and generate and provide a grade report to the management terminal.

For example, the carbon emission calculating unit 130 may classify a grade into grade A corresponding to low carbon emissions, grade B corresponding to medium carbon emissions, and grade C corresponding to high carbon emissions according to a criterion for determining an environmental evaluation grade based on carbon emissions.

Also, in an embodiment, the carbon emission calculating unit 130 may reflect environmental regulations and industrial standards of a relevant country or region in a process of determining such an environmental evaluation grade.

Also, the carbon emission calculating unit 130 compares the calculated carbon emissions with the criterion of the environmental evaluation grade, analyzes which grade a corresponding process belongs to, summarizes carbon emissions for each process, and identifies a major emission source (e.g., energy consumption or process emissions).

Next, the carbon emission calculating unit 130 may evaluate the impact of the calculated carbon emissions on an environment. For example, the impact of greenhouse gas emissions on local and global environments may be reflected. Also, the carbon emission calculating unit 130 may analyze whether additional process improvement is needed to reduce carbon emissions, and may analyze expected costs or environmental benefits when improvement is made.

The carbon emission calculating unit 130 may generate an environmental evaluation grade report to be provided to the management terminal, based on an analysis result.

In an embodiment, in the environmental evaluation grade report, the carbon emission calculating unit 130 may summarize an analysis result of carbon emissions generated in a scrap processing process, may reflect a purpose and a method of environmental evaluation, and may also reflect in detail a process of calculating carbon emissions, performing comparison with an evaluation criterion, determining a grade, and analyzing a major emission source.

Also, in the environmental evaluation grade report, the carbon emission calculating unit 130 may assign an environmental grade (e.g., A, B, C, etc.) according to an environmental evaluation result, may reflect recommendations on a method of reducing carbon emissions through process improvement, and may suggest long-term strategy or additional research needs to reduce environmental impact.

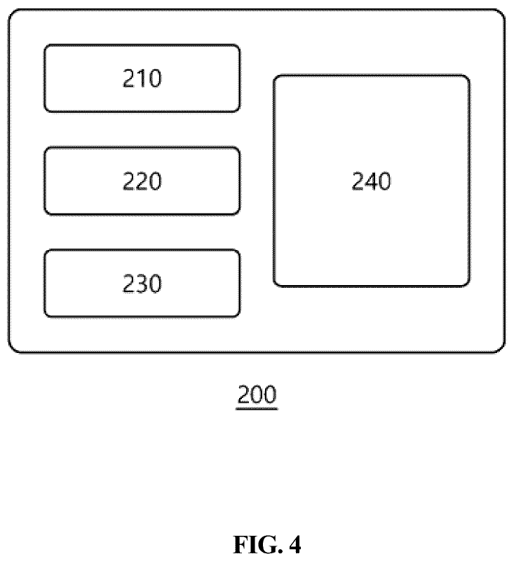

FIG. 4 is a diagram schematically illustrating a hardware configuration of the recycled metal processing system 100 using AI according to an embodiment of the present disclosure.

Referring to FIG. 4, the recycled metal processing system 100 using AI according to embodiments may be implemented as a computing device including hardware 200 and may include a memory 210, a processor 220, a communication module 230, and an input/output unit 240.

The memory 210 is a non-transitory computer-readable recording medium and may include a permanent mass storage device such as a random-access memory (RAM), a read-only memory (ROM), a disk drive, a solid state drive (SSD), or a flash memory. The permanent mass storage device such as ROM, SSD, flash memory, or disk drive may be stored, as a permanent storage device separate from the memory 210, in the device or a server.

Also, the memory 210 may store an operating system and at least one program code (e.g., code for an application installed to provide a specific service or a security module). Such software components may be loaded from a computer-readable recording medium separate from the memory 210. The separate computer-readable recording medium may include a computer-readable recording medium such as a floppy drive, a disk, a tape, a DVD/CD-ROM drive, or a memory card.

In another embodiment, the software components may be loaded into the memory 210 through the communication module 230, rather than the computer-readable recording medium. For example, at least one program may be loaded into the memory 210 based on a computer program installed by files provided through a network by a file distribution system (e.g., an application store service server) that distributes installation files of applications or developers.

The processor 220 may be configured to process a command of a computer program by performing basic arithmetic, logic, and input/output operations. The command may be provided to the processor 220 by the communication module 230 or the memory 210. For example, the processor 220 may be configured to execute a command received according to program code stored in a recording device such as the memory 210.

The communication module 230 may provide a function for the recycled metal processing system 100 using AI to communicate with a user terminal (not shown) through a network. Also, the communication module 230 may provide a function for the recycled metal processing system 100 using AI to communicate with one or more other devices through a wired and/or wireless network. That is, the communication module 230 is a portion that implements each functional module described with reference to FIG. 4 when a function of the communication module 230 is controlled by the processor 220 that references the memory 210.

The input/output unit 240 may be a means for interfacing with an external input/output device (not shown). For example, the external input device may include a device such as a keyboard, a mouse, a microphone, or a camera, and the external output device may include a device such as a display, a speaker, or a haptic feedback device. In another example, the input/output unit 240 may be a means for interfacing with a device in which input and output functions are integrated, such as a touchscreen.

Also, in other embodiments, the recycled metal processing system 100 using AI may include more hardware components than those illustrated in FIG. 4 according to the nature of an applied device. For example, the recycled metal processing system 100 using AI may include at least some of the above input/output devices or may further include other components such as a transceiver, a global positioning system (GPS) module, a camera, various sensors, and a DB. In a more specific example, when a terminal device is a smartphone, the recycled metal processing system 100 using AI may further include various components such as an acceleration sensor or a gyro sensor, a camera module, various physical buttons, buttons using a touch panel, an input/output port, and a vibrator for vibration which are generally provided in a smartphone.

However, components and a shape of a computing device described in the specification are only examples, and a configuration of the computing device implemented for the recycled metal processing system 100 using AI may be different from that described in the specification according to the adoption of other known technologies or further development of information and communication technologies.

Next, a method of processing recycled metal by using the recycled metal processing system 100 using AI described above will be sequentially described.

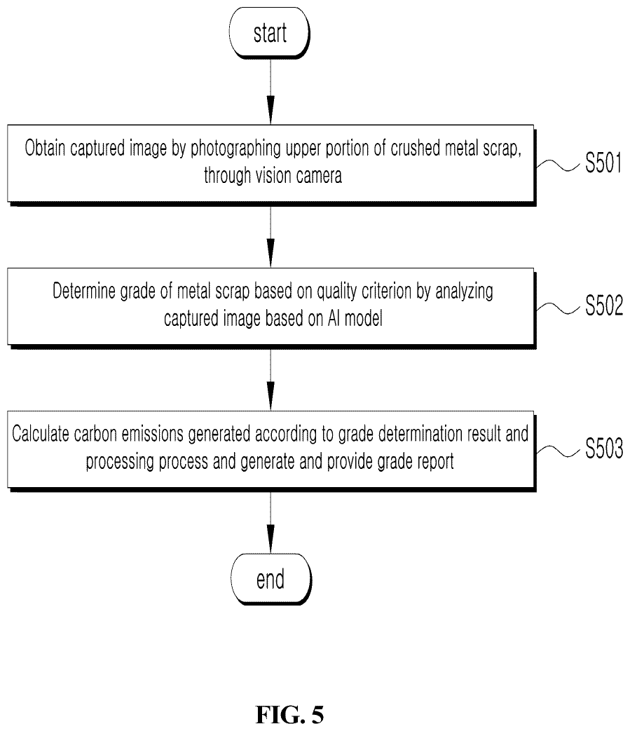

FIG. 5 is a flowchart sequentially illustrating a recycled metal processing method using AI according to an embodiment of the present disclosure.

Referring to FIG. 5, the recycled metal processing system 100 using AI according to an embodiment of the present disclosure obtains a captured image by capturing an image of an upper part of metal scrap through a vision camera installed above the metal scrap that is crushed (S501), and determines a grade of the metal scrap according to a preset quality criterion by analyzing the captured image based on an AI model through a grade determining unit (S502).

In operation S502, the grade determining unit may identify a type of the metal scrap by analyzing a material, a color, and a surface condition of the metal scrap based on the captured image obtained through the vision camera 110 and may classify by size or determine a processing process by measuring a length, a width, and a thickness of the metal scrap, and may also inspect a grade by detecting defects or impurities on the surface of the metal scrap.

Next, a carbon emission calculating unit calculates carbon emissions generated in a processing process of the metal scrap and a grade determination result for the metal scrap, generates a grade report on recycled metal based on the carbon emissions, and provides the grade report to a management terminal (S503).

In operation S503, the carbon emission calculating unit may calculate carbon emissions based on a material consumed in a metal scrap processing plant and corresponding energy consumption.

Also, in operation S503, the carbon emission calculating unit may determine carbon emissions generated in a process of processing a specific amount of specific classified metal scrap by using an AI model.

Also, in operation S503, the carbon emission calculating unit may compare the calculated carbon emissions with a criterion of an environmental evaluation grade, may analyze which grade a corresponding process belongs to, may summarize carbon emissions for each process, may identify a major emission source (e.g., energy consumption or process emissions), and may generate an environmental evaluation grade report to be provided to the management terminal based on an analysis result.

The method may be provided as a computer program stored in a computer-readable recording medium for execution on a computer. The medium may continuously store a computer-executable program, or may temporally store a computer-executable program for execution or download. Also, the medium may be any of various recording media or storage media having a single piece of hardware or a combination of several pieces of hardware, and the medium is not limited to a medium directly connected to a computer system, but may be distributed on a network. Examples of the medium may include magnetic media such as a hard disk, a floppy disk, and a magnetic tape, optical recording media such as a CD-ROM and a DVD, magneto-optical media such as a floptical disk, and devices configured to store program instructions such as a ROM, a random-access memory (RAM), and a flash memory. Also, other examples of the medium may include recording media and storage media managed by application stores distributing applications or by websites, servers, and the like supplying or distributing other various types of software.

The methods, operations, or techniques of the present disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the present disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on a particular application and an overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer-readable medium as one or more instructions or codes, or may be transmitted through a computer-readable medium. Computer-readable media include both computer storage media and communication media including any medium that facilitate transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that may be used to transfer or store desired program code in the form of instructions or data structures and may be accessed by a computer. Also, any connection is properly referred to as a computer-readable medium.

Although example implementations have been described as utilizing aspects of the presently disclosed subject matter in one or more standalone computer systems, the present disclosure is not limited thereto, and may be implemented in conjunction with any computing environment, such as a network or distributed computing environment. Furthermore, aspects of the presently disclosed subject matter may be implemented in a plurality of processing chips or devices, and storage may be similarly influenced across a plurality of devices. Such devices may include PCs, network servers, and portable devices.

Although the present disclosure has been described in connection with some embodiments herein, it should be understood that various modifications and changes may be made without departing from the scope of the present disclosure, which may be understood by those skilled in the art to which the present disclosure pertains. In addition, such modifications and changes should be considered within the scope of the claims appended herein.

What is claimed is:

1. A recycled metal processing system using artificial intelligence (AI), comprising:
a vision camera installed above metal scrap that is crushed, the vision camera being configured to obtain a captured image by capturing an image of an upper part of the metal scrap; and
a grade determining unit configured to determine a grade of the metal scrap according to a preset quality criterion, by analyzing the captured image based on an AI model.

2. The recycled metal processing system using AI according to claim 1, wherein, according to the quality criterion, a grade is classified into a plurality of grades according to whether the metal scrap corresponds to a vehicle outer skin, whether the metal scrap has a thickness of 3 mm or less, and whether the metal scrap has a thickness of 3 mm or less and is surface-plated,
wherein the grade determining unit is configured to classify a grade of the metal scrap based on the quality criterion.

3. The recycled metal processing system using AI according to claim 1, wherein the grade determining unit comprises:
a filtering unit configured to filter out shadow noise formed by lighting, a thermal noise component, and a dust noise component formed by scattering dust in the obtained captured image; and
a Fourier transform unit configured to perform Fourier transform on the filtered captured image.

4. The recycled metal processing system using AI according to claim 1, further comprising a carbon emission calculating unit configured to calculate carbon emissions generated in a processing process of the metal scrap and a grade determination result for the metal scrap, generate a grade report on recycled metal based on the carbon emissions, and provide the grade report to a management terminal.

5. A recycled metal processing method using artificial intelligence (AI), comprising:
obtaining, through a vision camera installed above metal scrap that is crushed, a captured image by capturing an image of an upper part of the metal scrap;
determining, through a grade determining unit, a grade of the metal scrap according to a preset quality criterion, by analyzing the captured image based on an AI model; and
through a carbon emission calculating unit, calculating carbon emissions generated in a processing process of the metal scrap and a grade determination result for the metal scrap, generating a grade report on recycled metal based on the carbon emissions, and providing the grade report to a management terminal.

6. A computer program stored in a computer-readable recording medium comprising a sequence of instructions for providing a recycled metal processing system using artificial intelligence (AI),
wherein, when the computer program is executed by a computing device, the sequence of instructions cause the computing device to
obtain, through a vision camera installed above metal scrap that is crushed, a captured image by capturing an image of an upper part of the metal scrap,
determine a grade of the metal scrap according to a preset quality criterion, by analyzing the captured image based on an AI model,
calculate carbon emissions generated in a processing process of the metal scrap and a grade determination result for the metal scrap, generate a grade report on recycled metal based on the carbon emissions, and provide the grade report to a management terminal.
